(19) United States
(12) Patent Application Publication
(10) Pub. No.: US 2015/0329068 A1
(43) Pub. Date: Nov. 19, 2015

(54) AUTOMATIC AUTOMOBILE LICENSE TAG

(71) Applicant: Panasonic Automotive Systems Company of America, Division of Panasonic Corporation of North America, Peachtree City, GA (US)

(72) Inventor: ROBERT ACKLIN, DUNWOODY, GA (US)

(73) Assignee: Panasonic Automotive Systems Company of America, Division of Panasonic Corporation of North America

(21) Appl. No.: 14/711,238

(22) Filed: May 13, 2015

Related U.S. Application Data
(60) Provisional application No. 61/992,265, filed on May 13, 2014.

(51) Int. Cl. B60R 13/10; G08B 5/36

(52) U.S. Cl. CPC B60R 13/10; G08B 5/36

(57) ABSTRACT

An automatic automobile license tag arrangement includes an electronic display tag mounted in association with a license plate of an automobile. A transmitter is associated with the vehicle and transmits display data to the electronic display tag. The electronic display tag is mounted in a corner of the license plate. The transmitter is disposed in an infotainment system of the vehicle. The infotainment system wirelessly receives the display data from a remote licensing office.

### CROSS-REFERENCE TO RELATED APPLICATIONS

This application claims the benefit of U.S. Provisional Application No. 61/992,265 filed on May 13, 2014, the disclosure of which is hereby incorporated by reference in its entirety for all purposes.

### BACKGROUND OF THE INVENTION

1. Field of the Invention

The present invention relates to an automobile license plate, and, more particularly, to a license tag for a license plate.

2. Description of the Related Art

Vehicle license tags must be renewed every year. Current license tags are static and a sticker must be applied for renewals. Another problem is that if a person relocates to a different state then he must apply for a new license tag at an office.

### SUMMARY OF THE INVENTION

The invention may provide an electronic display tag on a license plate which replaces a paper sticker type of license plate display tag. The electronic display tag may be controlled via radio frequency (RF) signals by the infotainment system of the vehicle on which the license plate is mounted. The display data transmitted from the infotainment system to the electronic display tag may be encrypted so that the display data cannot be maliciously changed by another party. The electronic display tag may transmit an RF acknowledgement signal back to the infotainment system.

The invention comprises, in one form thereof, an automatic automobile license tag arrangement including an electronic display tag mounted in association with a license plate of an automobile. A transmitter is associated with the vehicle and transmits display data to the electronic display tag.

The invention comprises, in another form thereof, a method of updating an automobile license tag, including mounting an electronic display tag in association with a license plate on an automobile. Display data is electronically transmitted from an infotainment system of the automobile to the electronic display tag.

The invention comprises, in yet another form thereof, an automatic automobile license tag arrangement including an electronic display tag mounted in association with a license plate of an automobile. The electronic display tag includes a receiver communicatively coupled to a display screen. The display screen has a height of less than three inches and a width of less than three inches. A first transmitter is associated with the vehicle and transmits display data to the electronic display tag for display on the display screen. An infotainment system of the automobile is communicatively coupled to the first transmitter. The electronic display tag includes a second transmitter transmitting an acknowledgement signal to the infotainment system in response to the electronic display tag receiving the display data. The infotainment system informs the driver of a malfunction of the electronic display tag if the acknowledgement signal is not received by the infotainment system within a predetermined period of time after the display data is transmitted to the electronic display tag.

An advantage of the present invention is that it may be automatically updated without an manual effort by the user.

Another advantage of the present invention is that it enables tag renewal to be displayed as well as any changes in the tag itself.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of one embodiment of an automatic automobile license tag arrangement of the present invention.

FIG. 2 is a block diagram of another embodiment of an automatic automobile license tag arrangement of the present invention.

FIG. 3 is a block diagram of yet another embodiment of an automatic automobile license tag arrangement of the present invention.

### DETAILED DESCRIPTION

### Glossary

Electronic Display Tag—device mounted in association with a vehicle license plate, and capable of presenting text or image data in visible form.
Infotainment System—Electronic device within a vehicle that provides entertainment content and/or information content to people in the vehicle.

The embodiments hereinafter disclosed are not intended to be exhaustive or limit the invention to the precise forms disclosed in the following description. Rather the embodiments are chosen and described so that others skilled in the art may utilize its teachings.

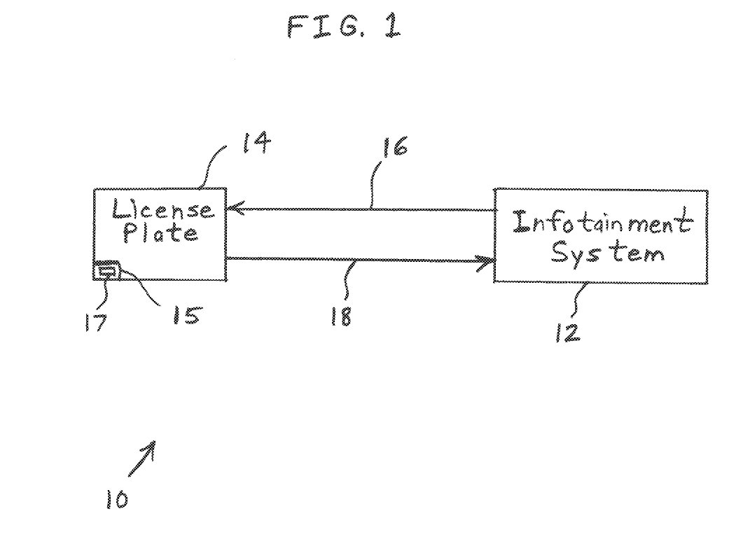

FIG. 1 is an automatic automobile license tag arrangement 10 of the present invention including an infotainment system 12 and a license plate 14 having an electronic display tag 15 in one of the four corners of license plate 14. The electronic display tag may include a display screen 17 that is rectangular and that may measure about one inch by two inches in one embodiment.

Infotainment system 12 may transmit encrypted display data, as indicated at 16, to the electronic display tag via RF signals. In response to receiving the display data, the electronic display tag may transmit an RF acknowledgement signal to infotainment system 12, as indicated at 18. If infotainment system 12 does not receive the acknowledgement signal within some certain time period after transmitting the display data, then infotainment system 12 may audibly or visibly inform the driver that the electronic display tag is malfunctioning.

The electronic display tag may be controlled by the car radio. The radio may control output to the display tag. Thus, the radio may be enabled to control the displayed content of the display tag, such as tag renewals or license plate renewals and other tag updates, etc. The radio may provide a secure link to the display tag, enabling renewals and changes in the tag to be displayed only after the changes have been checked on, and confirmation of the changes has been received.

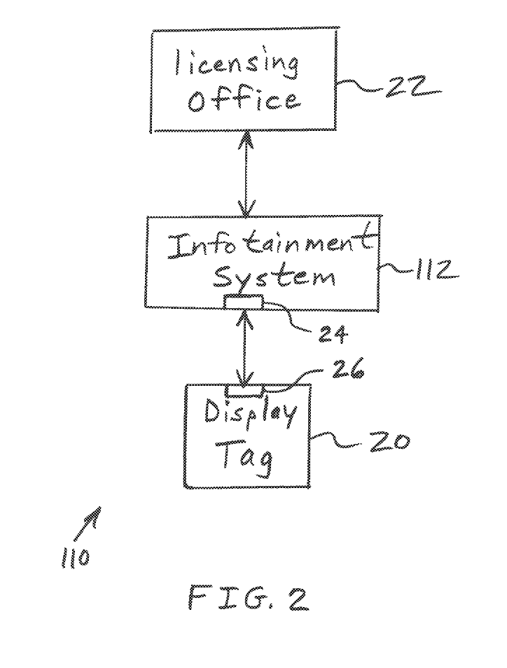

FIG. 2 is a block diagram of another embodiment of an automatic automobile license tag arrangement 110 of the present invention including an electronic display tag 20, an infotainment system 112 and a remote licensing office 22. Licensing office 22 may wirelessly transmit to infotainment system 112 the display data for display tag 20. Infotainment system 112 may include a transceiver 24 for performing bi-directional communication with licensing office 22 and with display tag 20. Display tag 20 may include a transceiver 26 for performing bi-directional communication. Other aspects of arrangement 110 may be substantially similar to those of arrangement 10.

In one embodiment, the display data is transmitted to the display tag continuously, or is refreshed at a selected time interval (e.g., approximately between every few seconds and every few weeks). In another embodiment, the display data is transmitted to the display tag only once, and display tag 20 uses and displays that display data until different display data is transmitted to display tag 20.

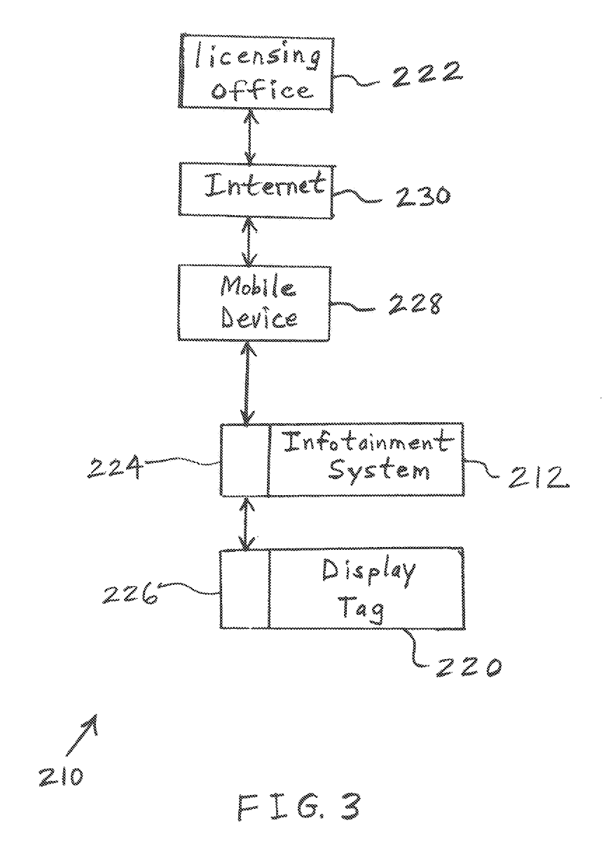

In another embodiment of an automatic automobile license tag arrangement 210 (FIG. 3) of the present invention, the user pays office 222 for the display tag renewal online, such as by use of his cell phone 228 via the Internet 230. In response, office 222 transmits to the user's cell phone 228, either via the Internet 230 or wirelessly via cellular communication, the display data for display tag 220. Cell phone 228 then downloads the display data to infotainment system 212 for re-transmission to display tag 220. Infotainment system 212 may include a transceiver 224 for performing bi-directional communication with electronic mobile device 228 and with display tag 220. Display tag 220 may include a transceiver 226 for performing bi-directional communication. Other aspects of arrangement 210 may be substantially similar to those of arrangement 10.

In yet another embodiment (not shown) an LCD display is attached over a tag. The LCD display is communicatively (e.g., wirelessly) coupled to the vehicle infotainment system such that the infotainment system may drive the output of the LCD display.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An automatic automobile license tag arrangement, comprising:
an electronic display tag configured to be mounted in association with a license plate of an automobile; and
a transmitter associated with the vehicle and configured to transmit display data to the electronic display tag.

2. The arrangement of claim 1, wherein the electronic display tag comprises a liquid crystal diode display.

3. The arrangement of claim 1, wherein the electronic display tag is configured to be mounted on a corner of the license plate.

4. The arrangement of claim 1, wherein the transmitter is disposed in an infotainment system of the vehicle.

5. The arrangement of claim 4, wherein the infotainment system is configured to wirelessly receive the display data from a remote licensing office.

6. The arrangement of claim 5, wherein the infotainment system is configured to wirelessly receive the display data from the remote licensing office via a cell phone.

7. The arrangement of claim 5, wherein the remote licensing office is configured to wirelessly transmit the display data in response to a user paying for a renewal of the license plate.

8. The arrangement of claim 1, wherein the display data is associated with a renewal of the license plate of the vehicle.

9. The arrangement of claim 1, wherein the transmitter associated with the vehicle comprises a transceiver, the electronic display tag including a transceiver configured to, in response to the electronic display tag receiving the display data, transmit an acknowledgement signal to the transceiver.

10. The arrangement of claim 1, wherein the display data is encrypted.

11. The arrangement of claim 1, wherein the display data is transmitted to the display tag continuously.

12. The arrangement of claim 1, wherein the display data is refreshed at a selected time interval approximately between every few seconds and every few weeks.

13. The arrangement of claim 1, wherein the display data is transmitted to the display tag only once, and the display tag is configured to use and display the display data until updated display data is transmitted to the display tag.

14. A method of updating an automobile license tag, the method comprising:
mounting an electronic display tag in association with a license plate on an automobile; and
electronically transmitting display data from an infotainment system of the automobile to the electronic display tag.

15. The method of claim 14, further comprising the infotainment system receiving the display data from a remote licensing office.

16. The method of claim 15, wherein the infotainment system wirelessly receives the display data from the remote licensing office via a cellular phone.

17. The method of claim 14, wherein the display data is associated with a renewal of the license plate of the vehicle.

18. The method of claim 14, further comprising the electronic display tag transmitting an acknowledgement signal to the infotainment system in response to receiving the display data.

19. An automatic automobile license tag arrangement, comprising:
an electronic display tag configured to be mounted in association with a license plate of an automobile, the electronic display tag including a receiver communicatively coupled to a display screen, the display screen having a height of less than three inches and a width of less than three inches; and
a transmitter associated with the vehicle and configured to transmit display data to the electronic display tag for display on the display screen.

20. The arrangement of claim 19, wherein the transmitter comprises a first transmitter, the arrangement further comprising an infotainment system in the automobile, the infotainment system being communicatively coupled to the first transmitter, the electronic display tag including a second transmitter configured to transmit an acknowledgement signal to the infotainment system in response to the electronic display tag receiving the display data, the infotainment system being configured to inform the driver of a malfunction of the electronic display tag if the acknowledgement signal is not received by the infotainment system within a period of time after the display data is transmitted to the electronic display tag.
